(19) United States
(12) Patent Application Publication
(10) Pub. No.: US 2026/0349505 A1
(43) Pub. Date: Nov. 5, 2026

(54) Binocular Foveated Rendering

(71) Applicant: Apple Inc., Cupertino, CA (US)

(72) Inventors: Milad Akhlaghi Bouzan, Redwood City, CA (US); Yashas Rai Kurlethimar, San Jose, CA (US)

(21) Appl. No.: 19/663,071

(22) Filed: Apr. 29, 2026

Related U.S. Application Data
(60) Provisional application No. 63/797,818, filed on Apr. 30, 2025.

(51) Int. Cl. G06F 3/01; G06T 3/40; G06T 19/00

(52) U.S. Cl. CPC G06F 3/013; G06T 3/40; G06T 19/006

(57) ABSTRACT

A method is performed at an electronic device including a processor, a non-transitory memory, and an eye tracking system. The method includes obtaining, from the eye tracking system, gaze data indicative of a first volumetric gaze region and a second volumetric gaze region. The first volumetric gaze region is associated with a first eye of a user, and the second volumetric gaze region is associated with a second eye of the user. The method includes rendering a first portion of an object according to a first rendering parameter, and rendering a second portion of the object according to a second rendering parameter different from the first rendering parameter. The rendering parameters may be based on overlap between the first portion of the object and the first and second volumetric gaze regions.

### CROSS-REFERENCE TO RELATED APPLICATIONS

This application claims priority to U.S. Provisional Patent App. No. 63/797,818, filed on Apr. 30, 2025, which is hereby incorporated by reference in its entirety.

### TECHNICAL FIELD

The present disclosure relates to systems, methods, and devices for performing foveated rendering.

### BACKGROUND

Rendering or otherwise processing an image can be computationally expensive. Accordingly, to reduce this computational burden, advantage is taken of the fact that humans typically have relatively weak peripheral vision. For example, in some systems, different portions of an object are rendered at different resolutions. However, inaccuracies associated with eye tracking often cause rendering of a relatively large portion of the object at a high resolution, resulting in high computational and power costs.

### SUMMARY

In accordance with some implementations, a method is performed at an electronic device including one or more processors, a non-transitory memory, and an eye tracking system. The method includes obtaining, from the eye tracking system, gaze data indicative of a first volumetric gaze region and a second volumetric gaze region. The first volumetric gaze region is associated with a first eye of a user, and the second volumetric gaze region is associated with a second eye of the user. In some implementations, the method includes identifying a first portion of an object by determining that the first portion of the object is spatially associated with a sub-region of the first volumetric gaze region, and a sub-region of the second volumetric gaze region. The method includes rendering the first portion of the object according to a first rendering parameter, and rendering a second portion of the object according to a second rendering parameter different from the first rendering parameter. In some implementations, the rendering is based on overlap between the object, the first volumetric gaze region, and the second volumetric gaze region.

In accordance with some implementations, an electronic device includes one or more processors, a non-transitory memory, and an eye tracking system. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of an electronic device, cause the device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is an example of an electronic device in accordance with some implementations.

FIGS. 3A-3G are an example of an electronic device performing binocular based foveated rendering according to various implementations.

FIG. 4 is an example of a flow diagram of a method of performing binocular based foveated rendering according to various implementations.

### DESCRIPTION OF IMPLEMENTATIONS

Rendering or otherwise processing an image can be computationally expensive. Accordingly, to reduce this computational burden, advantage is taken of the fact that humans typically have relatively weak peripheral vision. Accordingly, in some systems, different portions of an object are rendered at different resolutions. For example, in various implementations, a portion corresponding to a user's fovea is rendered at a higher resolution than a portion corresponding to a user's periphery. However, inaccuracies associated with eye tracking of the user (e.g., high noise or high latency) result in uncertainty regarding a user's focus, resulting in identification of a relatively large portion of an object to be rendered at a relative high resolution. Rendering a larger portion of the object at the high resolution is more computationally and power expensive, as compared with rendering a smaller portion of the object. Moreover, transmitting the larger rendered portion to other components of a graphics pipeline is associated with high bandwidth.

By contrast, various implementations disclosed herein include methods, electronic devices, and systems for binocular, volumetric eye tracking to identify a smaller region of on object to be rendered, resulting in lower processing and power costs. To that end, a method includes obtaining volumetric (e.g., three-dimensional (3D)) eye tracking information, which may be captured independently for each of eye of a user. For example, a first volumetric gaze region is obtained for a first eye of the user, and a second volumetric gaze region is obtained for a second eye of the user. Because of eye tracking inaccuracies, a gaze region is typically associated with a corresponding uncertainty region in space—e.g., uncertainty regarding the precise location in space on which the eye focuses. Other systems perform foveated rendering based on the entirety of an uncertainty region associated with a gaze region. Consequently, a system renders a relatively large portion of an object that corresponds to the entirety of the gaze region, resulting is high computational and power costs. In contrast, various implementations disclosed herein include rendering an object based on respective sub-regions associated with eye tracking of each eye, wherein the respective sub-regions together are smaller than the gaze region of the other systems. To that end, a method may include identifying a first portion of an object by determining that the first portion of the object is spatially associated with (e.g., display position of the object overlaps with) a sub-region of the first volumetric gaze region and a sub-region of the second volumetric gaze region. Moreover, the method includes rendering the first portion according to a first rendering parameter (e.g., at a higher resolution), and rendering a second portion according to a second rendering parameter (e.g., at a lower resolution). As compared with the other systems, the portion of the object to be rendered at a higher resolution—the first portion—is smaller, enabling more efficient foveated rendering from a processing and power perspective.

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

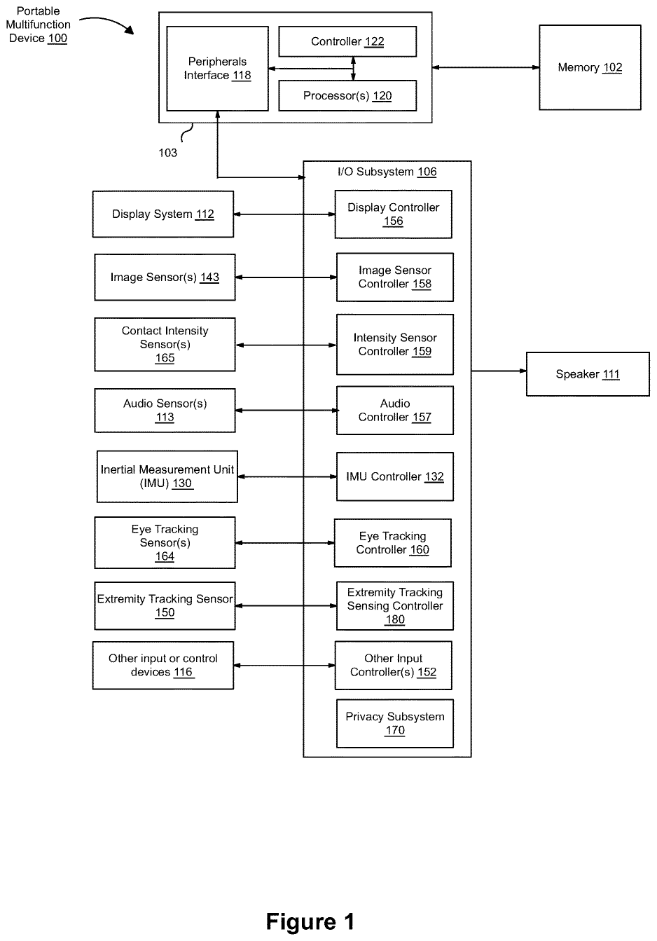

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, and a privacy subsystem 170. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, auxiliary device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time of flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 may have a touch-sensitive surface, sensor, or set of sensors that accepts input from the user based on haptic and/or tactile contact. The display system 112 and the display controller 156 (along with any associated systems and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or an auxiliary device.

In some implementations, the display system 112 corresponds to a display integrated in a head-mountable device (HMD), such as AR glasses. For example, the display system 112 includes a stereo display (e.g., stereo pair display) that provides (e.g., mimics) stereoscopic vision for eyes of a user wearing the HMD.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The user optionally makes contact with the display system 112 using any suitable object or appendage, such as an auxiliary device, an extremity (e.g., a finger), and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display. In various implementations, the eye tracking sensor(s) 164 generates gaze data indicative of a first volumetric gaze region and a second volumetric gaze region, wherein the first volumetric gaze region is associated with a first eye of a user, and wherein the second volumetric gaze region is associated with a second eye of the user. To that end, in some implementations, the eye tracking sensor(s) 164 includes a first eye tracking sensor that tracks the first eye of the user and a second eye tracking sensor that tracks the second eye of the user.

The extremity tracking sensor 150 obtains extremity tracking data indicative of a position of an extremity of a user. For example, in some implementations, the extremity tracking sensor 150 corresponds to a hand tracking sensor that obtains hand tracking data indicative of a position of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes. As another example, the privacy subsystem 170 anonymizes certain types of user information likely to include sensitive and/or identifying information, independent of user designation (e.g., automatically).

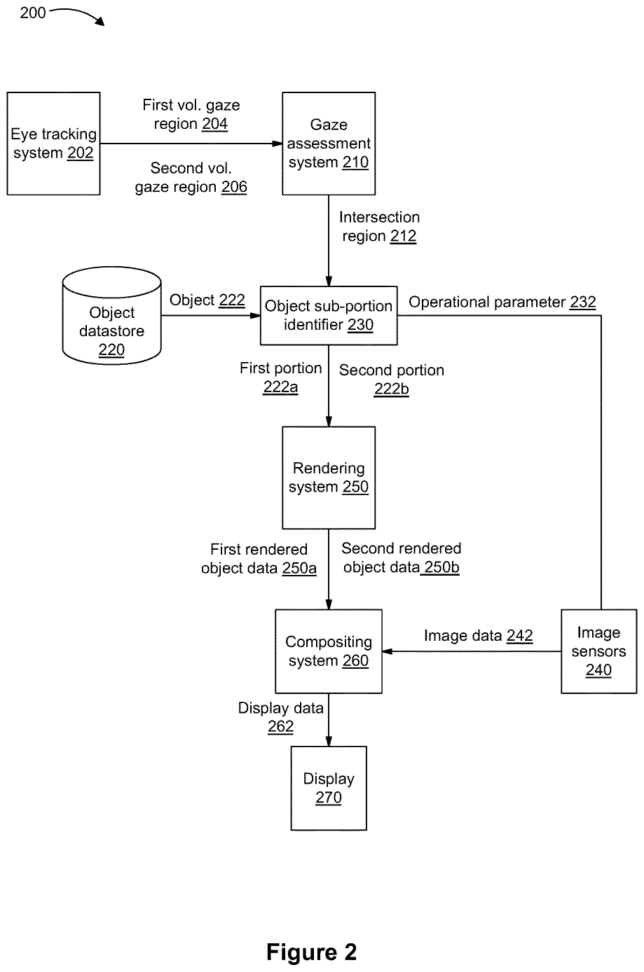

FIG. 2 is an example of an electronic device 200 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein.

The electronic device 200 includes an eye tracking system 202 for tracking eyes of a user, and generating corresponding gaze data. The gaze data indicates a first volumetric gaze region 204 associated with a first eye of the user and a second volumetric gaze region 206 associated with a second eye of the user. For example, each volumetric gaze region indicates 3D information regarding the gaze of a corresponding eye of the user. As one example, a volumetric gaze region corresponds to a plurality of 3D coordinate values (e.g., XYZ values) in 3D space. In some implementations, a volumetric gaze region corresponds to a 3D shape, such as a sphere, semi-sphere, cube, etc. One of ordinary skill in the art will appreciate that a volumetric gaze region may be any shape, such as a symmetrical 3D shape or an asymmetrical 3D shape. In some circumstances, a volumetric gaze region is associated with a dimensional characteristic (e.g., volume) that is a function of the level of uncertainty regarding the accuracies of the eye tracking. For example, a noisier eye tracking system 202 may result in larger volumetric gaze regions. In some circumstances, a volumetric gaze region is associated with a dimensional characteristic that is a function of depth associated with a gaze of a user. For example, for a user wearing an HMD, when a user gazes at a back wall of an XR environment, the eye tracking system 202 generates larger volumetric gaze regions 204 and 206, as compared to the user gazing at a feature of the XR environment that is closer to the HMD than the back wall.

In some implementations, the eye tracking system 202 includes one or more cameras that capture image data representing a series of images of the eyes of the user. For example, a camera is pointed towards the user and thus has a field of view that includes the eyes of the user. The eye tracking system 202 may be configured to perform computer vision regarding the image data, such identifying respective positions of the two eyes across the series of images via instance segmentation or semantic segmentation.

The electronic device 200 includes a gaze assessment system 210 that is configured to assess the first volumetric gaze region 204 and the second volumetric gaze region 206. To that end, in some implementations, the gaze assessment system 210 compares a first plurality of 3D coordinate values, comprising the first volumetric gaze region 204, against a second plurality of 3D coordinate values, comprising the second volumetric gaze region 206. For example, in some implementations, based on the comparison the gaze assessment system 210 determines an intersection region 212 in which the first volumetric gaze region 204 intersects with the second volumetric gaze region 206 in 3D space. Accordingly, in some implementations, the intersection region 212 indicates a plurality of 3D coordinate values (e.g., XYZ values) in 3D space. The intersection region 212 is characterized by a relatively high level of confidence regarding where the user is gazing.

In some implementations, the electronic device 200 includes an object datastore 220 that stores an object 222 to be rendered and/or stores object metadata that indicates information regarding the object 222 (e.g., display position of the object 222). To that end, in some implementations, the electronic device 200 includes a non-transitory memory that allocates a portion of memory to storage of the object 222 and/or the object metadata. In some implementations, the electronic device 200 does not include the object datastore 220, and instead obtains the object 222 and/or the object metadata from another device or system. In some implementations, the object metadata indicates a 3D position of the object 222, such as that the object 222 should be world-locked to a particular physical object within an XR environment.

In some implementations, the electronic device 200 includes an object sub-portion identifier 230 that identifies a first portion 222a of the object 222 that is spatially associated with each of first volumetric gaze region 204 and the second volumetric gaze region 206. For example, the first portion 222a of the object 222 has a display position that at least partially overlaps with the intersection region 212 in 3D space. Because the first portion 222a of the object 222 overlaps with the intersection region 212, it is likely that the user is gazing at the first portion 222a of the object 222. Thus, the first portion 222a of the object 222 may be rendered at a higher resolution than other portions of the object 222. In other words, the first portion 222a of the object 222 may be characterized as the foveated portion of the object, and a second portion 222b of the object 222 may be characterized as the non-foveated portion of the object 222. In some implementations, the size of the identified first portion 222a of the object 222 may decrease as an object depth (e.g., apparent distance between electronic device and displayed object) associated with the object decreases. For example, for an object 222 that is world-locked to a back wall of an XR environment, the depth of the object 222 decreases as the electronic device 200 moves closer to the back wall. The decrease of the depth of the object 222 enables the object sub-portion identifier 230 to identify a smaller first portion 222a of the object 222 for rendering. In some implementations, the object sub-portion identifier 230 identifies the second portion 222b of the object 222, to be rendered at a lower resolution. For example, the second portion 222b of the object 222 has a display position that does not overlap with the first volumetric gaze region 204 and/or the second volumetric gaze region 206.

In some implementations, the object sub-portion identifier 230 determines an operational parameter 232 of image sensors 240, which may be configured to capture image data 242 of a physical environment. The operational parameter 232 may be based on overlap between the object 222, the first volumetric gaze region 204, and the second volumetric gaze region 206. For example, the image sensors 240 include a left camera and a right camera that together capture the image data 242, to be used for generating an XR environment. Continuing with this example, the left camera captures a portion of the physical environment that has more overlap with the first portion 222a of the object 222 than a portion of the physical environment captured by the right camera. Accordingly, the operational parameter 232 may set the left camera to obtain image data at a higher resolution, frame rate, etc., as compared with the right camera.

The electronic device 200 includes a rendering system 250 that renders the object 222. To that end, in some implementations, the rendering system 250 includes or is communicatively coupled with a processor, such as a CPU or a graphics processing unit (GPU). According to various implementations, the rendering system 250 renders different portions of the object 222 according to different respective rendering parameters (e.g., resolution, pixel density). For example, the rendering system 250 renders the first portion 222a of the object 222 at a relatively high resolution, and renders the second portion 222b of the object 222 at a relatively low resolution. Continuing with this example, rendering the first portion 222a of the object 222 generates first rendered object data 250a, and rendering the second portion 222b of the object 222 generates second rendered object data 250b.

In some implementations, the electronic device 200 includes a compositing system 260 that is configured to generate an XR environment. To that end, the compositing system 260 may composite rendered object data (e.g., the first rendered object data 250a and the second rendered object data 250b) with the image data 242 of the physical environment. Compositing generates display data 262, to be displayed on a display 270 of the electronic device 200, thereby presenting a user with the XR environment.

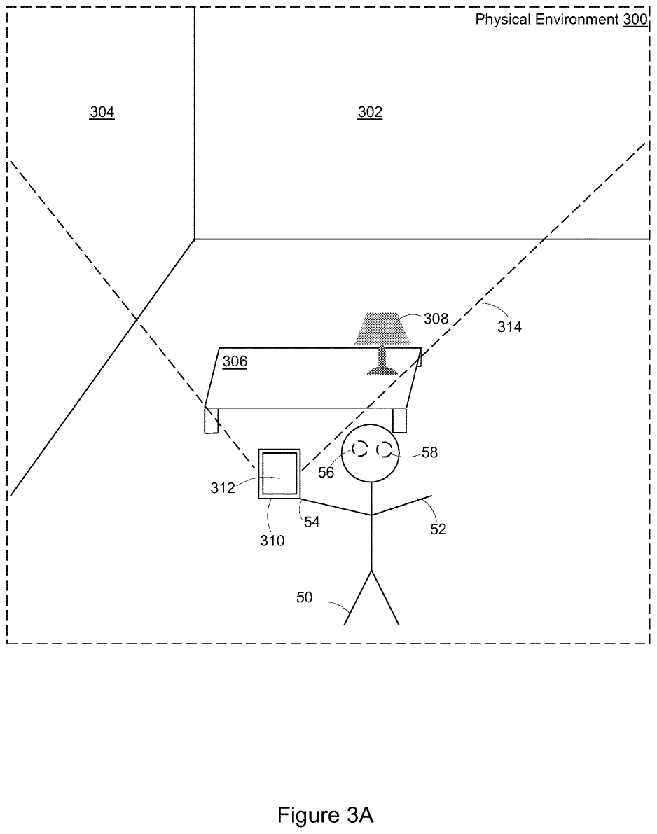

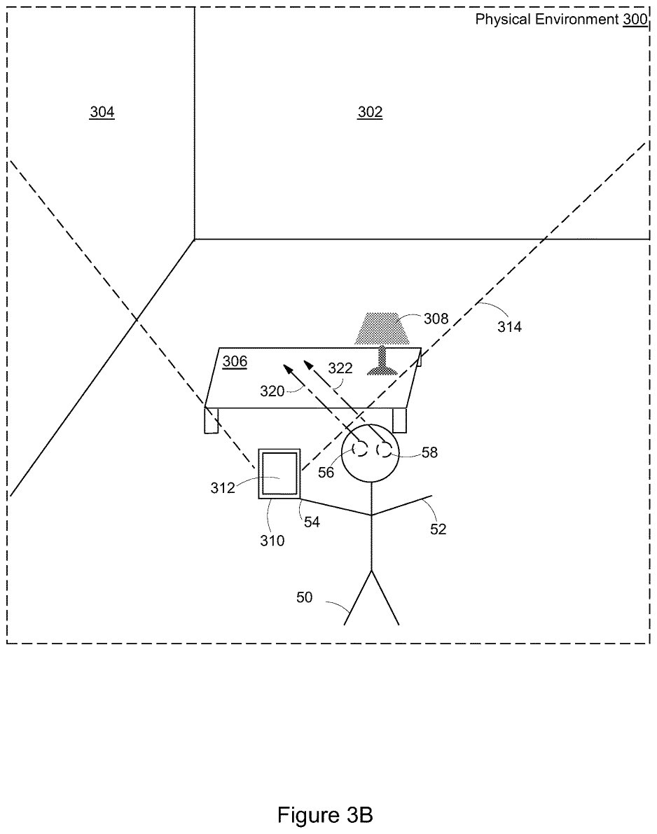

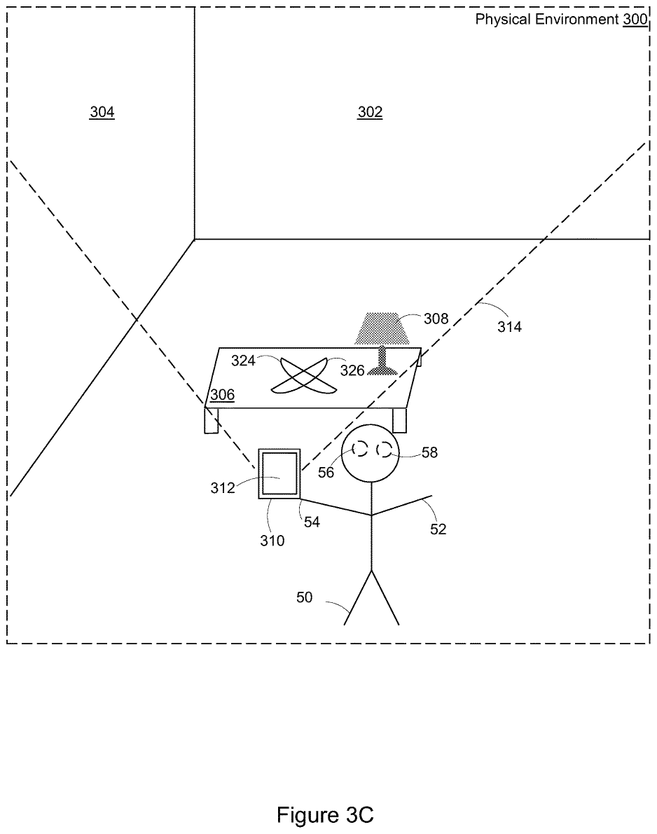

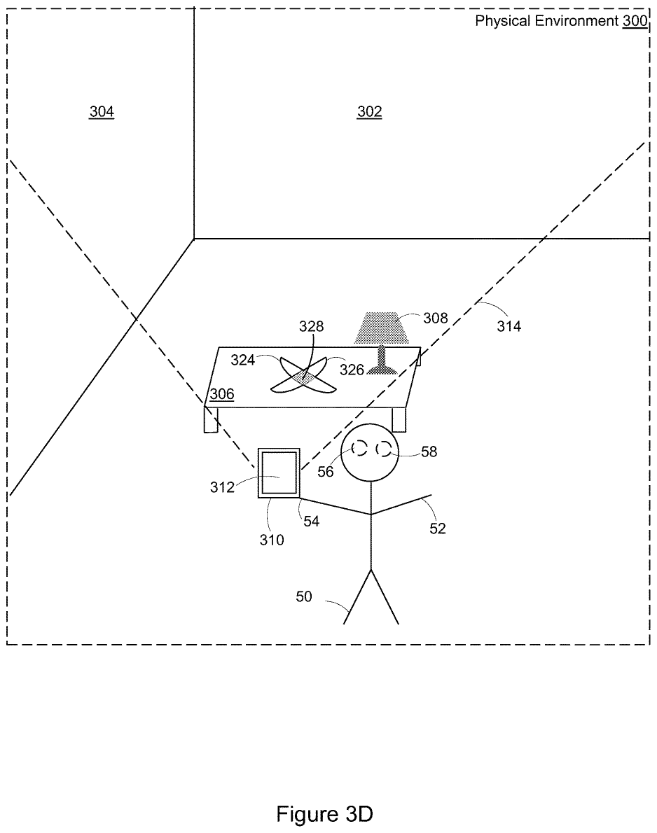

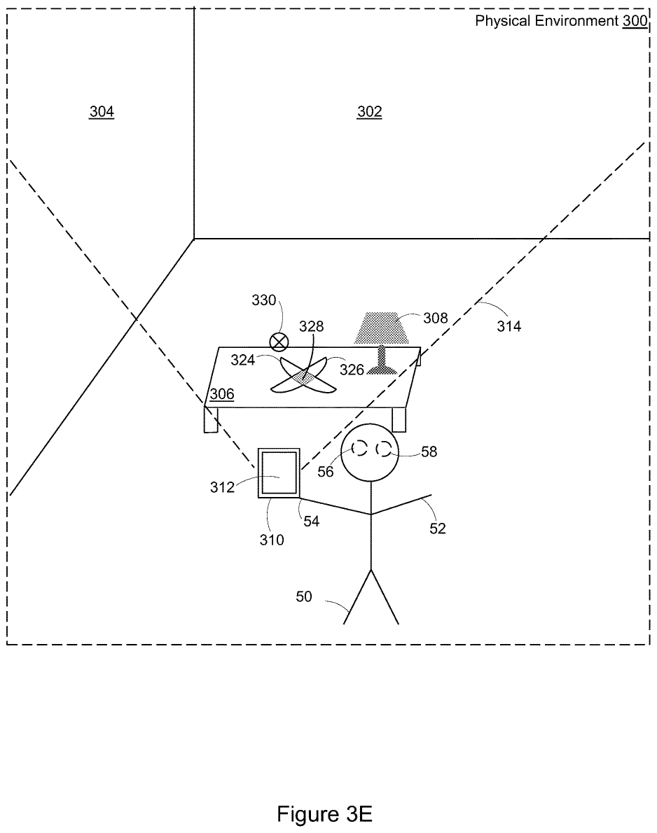

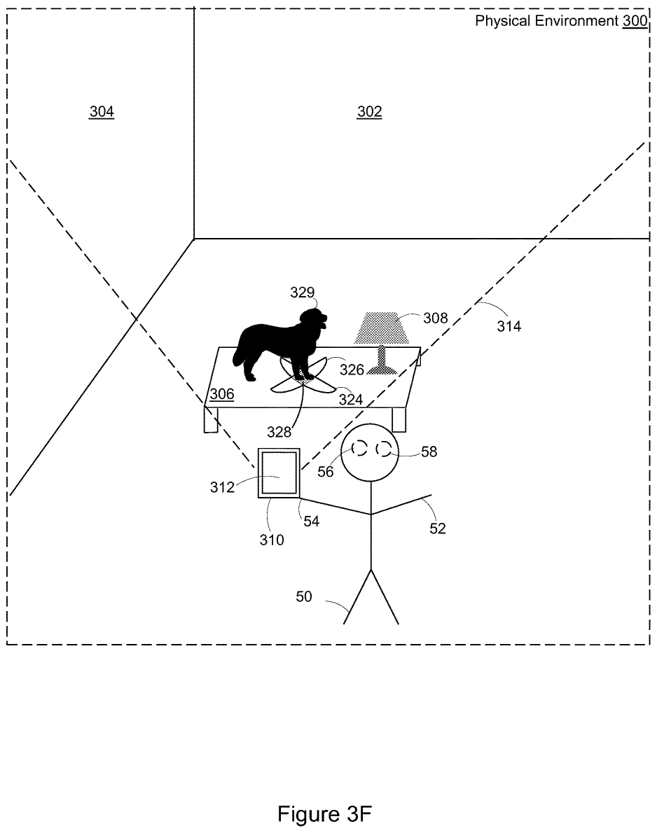

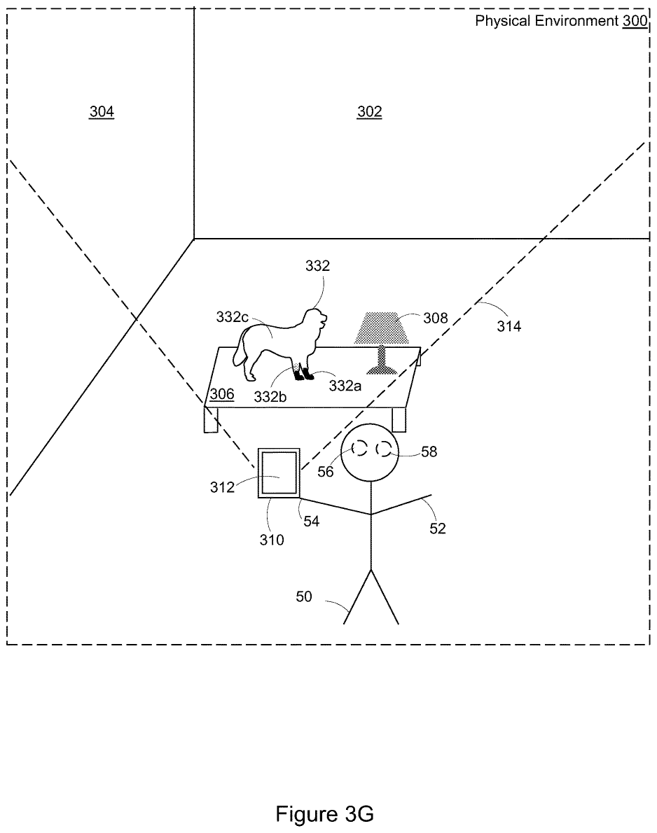

FIGS. 3A-3G are an example of an electronic device 310 performing binocular based foveated rendering according to various implementations. In some implementations, the electronic device 310 is similar to adapted from the electronic device 100 described with reference to FIG. 1. In some implementations, the electronic device 310 is similar to adapted from the electronic device 200 described with reference to FIG. 2. While pertinent features are shown, those of ordinary skill in the art will appreciate from the present disclosure that various other features have not been illustrated for the sake of brevity and so as not to obscure more pertinent aspects of the example implementations disclosed herein.

As illustrated in FIG. 3A, a user 50, with a left hand 54 and a right hand 52, is facing a portion of a physical environment 300. The physical environment 300 includes a first physical wall 302, a second physical wall 304, a physical table 306, and a physical lamp 308 lying on the physical table 306. The left hand 54 of the user 50 holds an electronic device 310, such as a tablet or smartphone. A left eye 56 of the user 50 and a right eye 58 of the user 50 are gazing at a portion of the physical environment 300.

The electronic device 310 includes a display 312 that is associated with a viewable region 314 of the physical environment 300. In some implementations, the electronic device 310 generates an XR environment for the user 50 by displaying display data on the display 312, wherein the display data corresponds to image data of the physical environment 300 composited with rendered object data. To that end, in some implementations, the electronic device 310 includes one or more image sensor(s) (e.g., a camera system) that capture image data associated with a field-of-view of the physical environment 300. The field-of-view may approximately correspond to the viewable region 314. For example, based on the viewable region 314 illustrated in FIG. 3A, the image data represents respective portions of the back wall 302, the side wall 304, and the physical table 306, as well as the entirety of the physical lamp 308. As another example, in some implementations, rather than capturing image data via the image sensor(s), the electronic device 310 includes a see-through display 312 that enables ambient light to enter from a portion of the physical environment 300 that is associated with the viewable region 314.

In some implementations, the electronic device 310 corresponds to a head-mountable device (HMD) that includes an integrated display (e.g., a built-in display) that displays a representation of the physical environment 300. In some implementations, the electronic device 310 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the electronic device 310). For example, in some implementations, the electronic device 310 slides/snaps into or otherwise attaches to the head-mountable enclosure. In some implementations, the display of the device attached to the head-mountable enclosure presents (e.g., displays) the representation of the physical environment 300. For example, in some implementations, the electronic device 310 corresponds to a mobile phone that can be attached to the head-mountable enclosure.

As illustrated in FIG. 3B, the left eye 56 of the user 50 focuses on a first region of the physical table 306, as indicated by a first gaze line 320. The right eye 58 of the user 50 focuses on a second region of the physical table 306, as indicated by a second gaze line 322. According to various implementations, the electronic device 310 includes an eye tracking system that tracks the left eye 56 and the right eye 58, and generates corresponding gaze data characterizing each eye gaze position in 3D space. For example, as illustrated in FIG. 3C, the gaze data indicates a first volumetric gaze region 324 of the physical environment 300, wherein the first volumetric gaze region 324 is associated with the left eye 56. Moreover, the gaze data indicates a second volumetric gaze region 326 of the physical environment 300, wherein the second volumetric gaze region 326 is associated with the right eye 58. The first gaze line 320 and the second gaze line 322 have been removed from FIGS. 3C-3G, for greater illustrative clarity. The first volumetric gaze region 324 and/or second volumetric gaze region 326 may or may not be displayed on the display 312.

Each of the first volumetric gaze region 324 and the second volumetric gaze region 326 corresponds to a 3D semi-sphere, comprising a respective set of points in 3D space. One of ordinary skill in art will appreciate that a volumetric gaze region may be any type of volumetric shape, where the corresponding gaze data indicates a plurality of points in 3D space that comprise the volumetric shape. In some implementations, the dimensional characteristic (e.g., size or volume) of a volumetric gaze region is a function of the accuracy of the eye tracking system and/or a depth associated with the gaze, which itself may affect the accuracy of the eye tracking system. For example, for a gaze that is instead directed to the back wall 302, the eye tracking system may generate gaze data indicating larger volumetric gaze regions because the back wall 302 is farther from the electronic device 310 than the physical table 306 is from the electronic device 310.

Other systems may render, at a high resolution, a portion of an object that overlap with the entirety of one or more gaze regions. Accordingly, the rendered portion of the object is relatively large, consuming a relatively large amount of processing and power resources.

By contrast, methods, device, and systems disclosed herein include identifying a smaller portion of the object to render at a high resolution. As one example, as illustrated in FIG. 3D, the electronic device 310 identifies an intersection region 328, of the physical environment 300, in which the first volumetric gaze region 324 intersects with the second volumetric gaze region 326 in 3D space. Thus, the intersection region 328 comprises a plurality of 3D coordinate values indicating corresponding positions in 3D space. The intersection region 328 is smaller than each of the first volumetric gaze region 324 and the second volumetric gaze region 326, enabling foveated rendering to performed on a smaller portion of an object, thereby reducing processor and power utilization. The intersection region 328 may or may not be displayed by on display 312.

As an example, the electronic device 310 obtains a dog object 329 (e.g., from the object datastore 220 of FIG. 2), and renders different portions of the dog object 329 according to different rendering parameters based on volumetric gaze regions. Rendering the dog object 329 results in generation of a rendered dog object 332. To that end, in some implementations, the electronic device 310 obtains object metadata associated with the dog object 329, wherein the object metadata indicates a display position of the dog object 329 in a physical environment. For example, as illustrated in FIG. 3E, a positional indicator 330 indicates the display position of the dog object 329. The positional indicator 330 may or may not be displayed on the display 312. In various implementations, based on a dimensional characteristic (e.g., volume) of the dog object 329 and the display position of the dog object 329, the electronic device 310 identifies one or more portions of the dog object 329 on which to be perform foveated rendering. For example, FIG. 3F illustrates, for explanatory purposes, the (pre-rendered) dog object 329 positioned at the display position. Continuing with this example, the electronic device 310 identifies a first portion of the dog object 329 that is within the intersection region 328, wherein the first portion of the dog object 329 corresponds to the front ankle and feet of the dog object 329. In some implementations, the electronic device 310 identifies a second portion of the dog object 329 that is outside of the intersection region 328, but overlaps with one of the first volumetric gaze region 324 or the second volumetric gaze region 326. Namely, the second portion of the dog object 329 corresponds to the upper portion of the front right leg of the dog object 329, which overlaps with the first volumetric gaze region 324 in 3D space. In some implementations, the electronic device 310 identifies a third portion of the dog object 329 that is outside of the first volumetric gaze region 324 and outside of the second volumetric gaze region 326. Namely, the third portion of the dog object 329 corresponds to the remainder of the dog object 329—e.g., head, torso, back legs, and portion of front legs not part of the first and second portions. In some implementations, the electronic device 310 renders the first portion of the dog object 329 according to a first rendering parameter, renders the second portion of the dog object 329 according to a second rendering parameter different from the first rendering parameter, and renders the third portion of the dog object 329 according to a third rendering parameter different from the first and second rendering parameters. Because the first portion of the dog object 329 overlaps with the intersection region 328, there is a high likelihood the user 50 is gazing at the first portion of the dog object 329. Thus, the electronic device 310 renders the first portion of the dog object 329 such that resulting first rendered object data 332a has a high resolution level. Moreover, because the second portion of the dog object 329 does not overlap with the intersection region 328 but overlaps with the first volumetric gaze region 324, there is a medium likelihood the user 50 is gazing at the second portion of the dog object 329. Thus, the electronic device 310 renders the second portion of the dog object 329 such the resulting second rendered object data 332b has a medium resolution level. Moreover, because the third portion of the dog object 329 does not overlap first volumetric gaze region 324 or with the first volumetric gaze region 326, there is a low likelihood the user 50 is gazing at the third portion of the dog object 329. Thus, the electronic device 310 renders the third portion of the dog object 329 such the resulting third rendered object data 332c has a low resolution level.

FIG. 3G illustrates the rendered dog object 332 including the first rendered object data 332a having the high resolution, the second rendered object data 332b having the medium resolution, and the third rendered object data 332c having the low resolution. The first rendered object data 332a is indicated via black coloring, the second rendered object data 332b is indicated via gray coloring, and the third rendered object data 332c is indicated via white coloring.

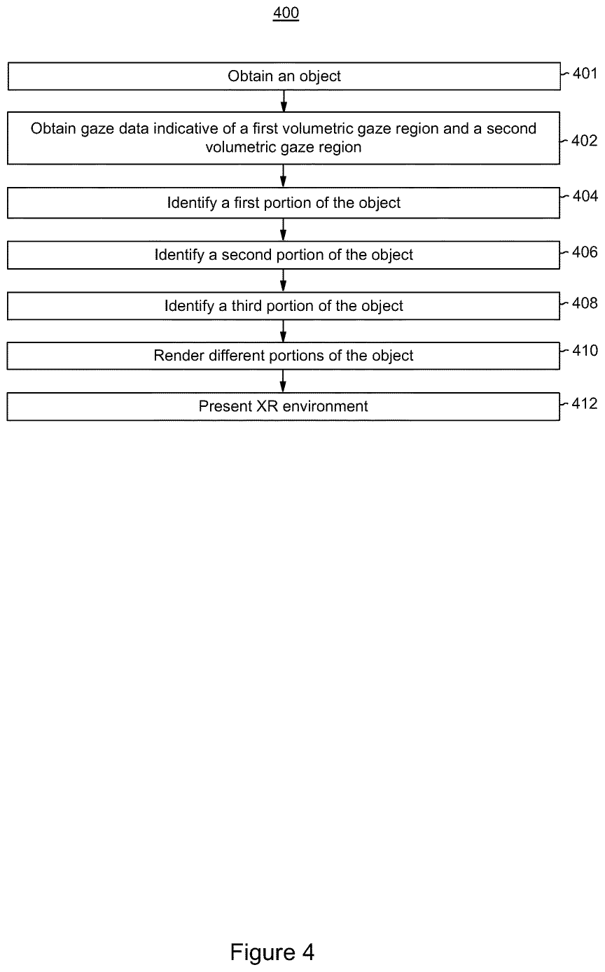

FIG. 4 is an example of a flow diagram of a method 400 of performing binocular based foveated rendering according to various implementations. In various implementations, the method 400 or portions thereof are performed by an electronic device including one or more processors, a non-transitory memory, and an eye tracking system. For example, the electronic device 200 described with reference to FIG. 2 performs the method 400. As another example, the electronic device 310 described with reference to FIGS. 3A-3G performs the method 400. In various implementations, the method 400 or portions thereof are performed by a head-mountable device (HMD). In some implementations, the method 400 is performed by processing logic, including hardware, firmware, software, or a combination thereof. In some implementations, the method 400 is performed by a processor executing code stored in a non-transitory computer-readable medium (e.g., a memory). In various implementations, some operations in method 400 are, optionally, combined and/or the order of some operations is, optionally, changed.

In some implementations, as represented by block 401, the method 400 includes obtaining an object. For example, with reference to FIG. 2, the electronic device 200 obtains the object 222 from the object datastore 220. In some implementations, the object corresponds to a world-lock object, such as an object that is anchored to a point or region of a physical environment. For example, with reference to FIG. 3F, the dog object 329 may be associated with a display position that is world-locked to an anchor point of the physical table 306. Accordingly, with reference to FIG. 3G, a movement of the electronic device 310 (e.g., detected by an IMU of the electronic device 310), may result in the electronic device 310 moving the rendered dog object 332 on the display 312 such that the rendered dog object 332 remains world-locked to the anchor point of the physical table 306.

As represented by block 402, the method 400 includes obtaining, from the eye tracking system, gaze data indicative of a first volumetric gaze region and a second volumetric gaze region. The first volumetric gaze region is associated with a first eye of a user, and the second volumetric gaze region is associated with a second eye of the user. For example, the gaze data is generated by the eye tracking system 202 of FIG. 2. As another example, with reference to FIG. 3C, an eye tracking system of the electronic device 310 obtains gaze data indicative of the first volumetric gaze region 324 and the second volumetric gaze region 326. Continuing with this example, the first volumetric gaze region 324 is associated with a gaze of the first eye 56, and the second volumetric gaze region 326 is associated with a gaze of the second eye 58. Each volumetric gaze region may be defined by a plurality of 3D coordinate values in 3D space, such as a plurality of 3D coordinate values within a physical environment (e.g., the physical environment 300). In some implementations, the eye tracking system determines the first volumetric gaze region according to a first confidence level, and the eye tracking system determines the second volumetric gaze region according to a second confidence level different from the first confidence level. Thus, in some implementations, eye tracking is performed independently for each eye.

As represented by block 404, the method 400 identifying a first portion of the object by determining that the first portion of the object is spatially associated with a sub-region of the first volumetric gaze region and with a sub-region of the second volumetric gaze region. For example, identifying the first portion of the object is performed by the object sub-portion identifier 230 of FIG. 2. To that end, in some implementations, identifying the first portion of the object includes determining an intersection region in which the first volumetric gaze region intersects with the second volumetric gaze region, and determining that the first portion of the object is spatially associated with the intersection region. For example, the method 400 includes determining that the first portion of the object is associated with a display position that overlaps with the intersection region. For example, with reference to FIG. 3F, the electronic device identifies, as the first portion of the dog object 329, the front ankle and feet of the dog object 329 by determining that this portion of the dog object 329 has a display position that overlaps with the intersection region 328 in 3D space.

In some implementations, the first portion of the object is identified in 3D space. To that end, the method 400 may include translating each of the first volumetric gaze region and the second volumetric gaze region to a common frame of reference, identifying the intersection region within the common frame of reference, and translating the intersection region within the common frame of reference to respective portions of the first volumetric gaze region and the second volumetric gaze region.

In some implementations, the first portion of the object is identified in two-dimensional (2D) space. To that end, the method 400 may include projecting each of the first volumetric gaze region and the second volumetric gaze region to a 2D plane based on an estimated vergence depth, and identifying the intersection region within the 2D plane. For example, a binocular eye tracking system determines the first and second volumetric gaze regions, determines an estimated fixation (e.g., gaze) point based on the first and second volumetric gaze regions, and determines the estimated vergence depth based on the estimated fixation point. Continuing with this example, each of the first and second volumetric gaze regions is projected to the 2D plane at the estimated vergence depth.

In some implementations, the first volumetric gaze region is associated with a first depth, the second volumetric gaze region is associated with a second depth, and the intersection region is associated with a dimensional characteristic that is proportional to the first and second depths. For example, with reference to FIG. 3D, if the user's gaze moved from the physical table 306 to the back wall 302, respective depths associated with each volumetric gaze region 324 and 326 would increase. Moreover, the accuracy of eye tracking may decrease as gaze depth increases, resulting in each of the volumetric gaze region 324 and 326 increasing in size, and thus resulting in the intersection region 328 also increasing in size. Moreover, in some implementations, the first portion of the object is associated with a dimensional characteristic that is based on the dimensional characteristic associated with the intersection region. Thus, as the gaze depth increases, the size of the first portion of the object may also increase, resulting in foveated rendering of a larger portion of the object.

In some implementations, the sub-region of the first volumetric gaze region and the sub-region of the second volumetric gaze region are together smaller than each of the first volumetric gaze region and the second volumetric gaze region. Thus, performing high resolution rendering of the first portion of the object, which is associated with the sub-region of the first volumetric gaze region and the sub-region of the second volumetric gaze region, results in computational and power savings, and compared with performing high resolution rendering of a portion of the object associated with the entirety of the first or second volumetric gaze regions.

In some implementations, as represented by block 406, the method 400 includes identifying a second portion of the object. To that end, in some implementations, the method 400 includes identifying the second portion of the object by determining that the second portion of the object is not spatially associated with the intersection region. For example, in some implementations, determining that the second portion of the object is not spatially associated with the intersection region includes determining that the second portion of the object is spatially associated with a portion of the first volumetric gaze region that is outside of the intersection region. In this example, because the second portion of the object is within a gaze region of one eye of a user, the method 400 may include rendering the second portion of the object at a medium resolution level, which is lower than a resolution level associated with rendering of the first portion of the object. For example, identifying the second portion of the object is performed by the object sub-portion identifier 230 of FIG. 2. As another example, with reference to FIG. 3F, the electronic device identifies, as the second portion of the dog object 329, the upper portion of the front right leg of the dog object 329 by determining that this portion of the dog object 329 has a display position that overlaps with the first volumetric gaze region 324 in 3D space.

In some implementations, as represented by block 408, the method 400 includes identifying a third portion of the object that is not spatially associated with the first volumetric gaze region or with the second volumetric gaze region. Moreover, the method 400 may include rendering the third of the second portion of the object at a lower resolution than rendering of the second portion of the object, because the third portion is positioned outside of respective gaze regions of both eyes of the user. For example, identifying the third portion of the object is performed by the object sub-portion identifier 230 of FIG. 2. As another example, with reference to FIG. 3G, the electronic device identifies, as the third portion of the dog object 329, the head, torso, back legs, and portion of front legs not part of the first and second portions, by determining that this portion of the dog object 329 has a display position that does not overlap with the first volumetric gaze region 324 or the second volumetric gaze region 326 in 3D space.

As represented by block 410, the method 400 includes rendering the first portion of the object according to a first rendering parameter, and rendering a second portion of the object according to a second rendering parameter different from the first rendering parameter. As one example, the rendering is performed by the rendering system 250 of FIG. 2. In some implementations, the first rendering parameter indicates a relatively high resolution level, and the second rendering parameter indicates a relatively low resolution level. In some implementations, the method 400 includes rendering the third portion of the object according to a third rendering parameter different from the first and second rendering parameters. For example, with reference to FIGS. 3F and 3G, the method 400 includes rendering the front ankle and feet of the dog object 329 (first portion) according to a high resolution level, rendering the upper portion of the front right leg of the dog object 329 (second portion) according to a medium resolution level, and rendering the remainder of the dog object 329 (third portion) according to a low resolution level.

In some implementations, rendering is performed independently for each eye. To that end, in some implementations, rendering the first and second portions of the object includes generating first rendered object data associated with the first eye of the user and generating second rendered object data associated with the second eye of the user.

In some implementations, as represented by block 412, the method 400 includes presenting an XR environment to a user. For example, the display 270 of FIG. 2 or the display 312 of FIGS. 3A-3G present the XR environment. To that end, the method 400 may include concurrently displaying a representation of a physical environment (e.g. pass-through image data), the first rendered object data, and the second rendered object data. To that end, in some implementations, the method 400 includes capturing via image sensors, image data of a physical environment, generating display data by compositing the image data with the first and second rendered object data, and displaying the display data on the display. For example, the image sensors 240 of FIG. 2 capture the image data 242. As another example, with reference to FIG. 3G, the electronic device 310 concurrently displays, on the display 312, image data of the physical environment 300, the first rendered object data 332a, the second rendered object data 332b, and the third rendered object data 332c. In some implementations, the method 400 includes setting an operational parameter of the image sensors by which to capture the image data, wherein the operational parameter is based on overlap between the object, the first volumetric gaze region, and the second volumetric gaze region. For example, the image sensors 240 of FIG. 2 capture the image data 242 while being set to the operational parameter 232. As another example, the image sensors include a left camera and a right camera that together capture image data of a physical environment, to be used for generating an XR environment. As one example, the left camera captures a portion of a physical environment that has more overlap with the first portion of the object than a portion of the physical environment captured by the right camera. Accordingly, the operational parameter may indicate that the left camera should be set to obtain image data at a higher resolution, frame rate, etc. than the right camera. In some implementations, the method 400 includes performing an image processing operation on the image data, based on the overlap.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or systems stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user's personal information. For example, such personal information may be utilized in order to provide an improved privacy screen on an electronic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at an electronic device including a processor, a non-transitory memory, and an eye tracking system:
obtaining, from the eye tracking system, gaze data indicative of a first volumetric gaze region and a second volumetric gaze region, wherein the first volumetric gaze region is associated with a first eye of a user, and wherein the second volumetric gaze region is associated with a second eye of the user;
identifying a first portion of an object by determining that the first portion of the object is spatially associated with:
a sub-region of the first volumetric gaze region, and
a sub-region of the second volumetric gaze region; and
rendering the first portion of the object according to a first rendering parameter, and rendering a second portion of the object according to a second rendering parameter different from the first rendering parameter.

2. The method of claim 1, wherein identifying the first portion of the object includes:
identifying an intersection region in which the first volumetric gaze region intersects with the second volumetric gaze region; and
determining that the first portion of the object is spatially associated with the intersection region.

3. The method of claim 2, wherein the first portion of the object is identified in 3D space by:
translating each of the first volumetric gaze region and the second volumetric gaze region to a common frame of reference;
identifying the intersection region within the common frame of reference; and
translating the intersection region within the common frame of reference to respective portions of the first volumetric gaze region and the second volumetric gaze region.

4. The method of claim 2, wherein the first portion of the object is identified in two-dimensional (2D) space by:
projecting each of the first volumetric gaze region and the second volumetric gaze region to a 2D plane based on an estimated vergence depth; and
identifying the intersection region within the 2D plane.

5. The method of claim 2, further comprising identifying the second portion of the object by determining that the second portion of the object is not spatially associated with the intersection region.

6. The method of claim 5, wherein identifying the second portion of the object includes determining that the second portion of the object is spatially associated with a portion of the first volumetric gaze region that is outside of the intersection region.

7. The method of claim 6, further comprising identifying a third portion of the object by determining that the third portion of the object is not spatially associated with the first volumetric gaze region or with the second volumetric gaze region, the method further comprising rendering the third portion of the object according to a third rendering parameter different from the first and second rendering parameters.

8. The method of claim 2, wherein the first volumetric gaze region is associated with a first depth, wherein the second volumetric gaze region is associated with a second depth, and wherein the intersection region is associated with a dimensional characteristic that is proportional to the first and second depths.

9. The method of claim 8, wherein the first portion of the object is associated with a dimensional characteristic that is based on the dimensional characteristic associated with the intersection region.

10. The method of claim 1, wherein the sub-region of the first volumetric gaze region and the sub-region of the second volumetric gaze region are together smaller than each of the first volumetric gaze region and the second volumetric gaze region.

11. The method of claim 1, wherein rendering the first and second portions of the object includes generating first rendered object data associated with the first eye of the user and generating second rendered object data associated with the second eye of the user.

12. The method of claim 11, wherein the electronic device includes a display and image sensors, the method further comprising:
capturing, via the image sensors, image data of a physical environment;
generating display data by compositing the image data with the first and second rendered object data; and
displaying the display data on the display.

13. The method of claim 12, further comprising setting an operational parameter of the image sensors based on overlap between the object, the first volumetric gaze region, and the second volumetric gaze region.

14. The method of claim 13, further comprising performing an image processing operation based on the overlap.

15. The method of claim 1, wherein the eye tracking system determines the first volumetric gaze region according to a first confidence level, and wherein the eye tracking system determines the second volumetric gaze region according to a second confidence level different from the first confidence level.

16. The method of claim 1, wherein the first rendering parameter indicates a first resolution level for the first portion of the object, wherein the second rendering parameter indicates a second resolution level for the second portion of the object, and wherein the first resolution level is different from the second resolution level.

17. An electronic device comprising:
one or more processors;
a non-transitory memory;
an eye tracking system; and
one or more programs stored in the non-transitory memory, which, when executed by the one or more processors, cause the electronic device to perform:
obtaining, from the eye tracking system, gaze data indicative of a first volumetric gaze region and a second volumetric gaze region, wherein the first volumetric gaze region is associated with a first eye of a user, and wherein the second volumetric gaze region is associated with a second eye of the user;
identifying a first portion of an object by determining that the first portion of the object is spatially associated with:
a sub-region of the first volumetric gaze region, and
a sub-region of the second volumetric gaze region; and
rendering the first portion of the object according to a first rendering parameter, and rendering a second portion of the object according to a second rendering parameter different from the first rendering parameter.

18. The electronic device of claim 17, wherein identifying the first portion of the object includes:
identifying an intersection region in which the first volumetric gaze region intersects with the second volumetric gaze region; and
determining that the first portion of the object is spatially associated with the intersection region.

19. A non-transitory memory storing one or more programs, which, when executed by one or more processors of an electronic device including an eye tracking system, cause the electronic device to perform:
obtaining, from the eye tracking system, gaze data indicative of a first volumetric gaze region and a second volumetric gaze region, wherein the first volumetric gaze region is associated with a first eye of a user, and wherein the second volumetric gaze region is associated with a second eye of the user,
identifying a first portion of an object by determining that the first portion of the object is spatially associated with:
a sub-region of the first volumetric gaze region, and
a sub-region of the second volumetric gaze region; and
rendering the first portion of the object according to a first rendering parameter, and rendering a second portion of the object according to a second rendering parameter different from the first rendering parameter.

20. The non-transitory of claim 19, wherein identifying the first portion of the object includes:
identifying an intersection region in which the first volumetric gaze region intersects with the second volumetric gaze region; and
determining that the first portion of the object is spatially associated with the intersection region.
